(19) United States
(12) Patent Application Publication
(10) Pub. No.: US 2002/0141568 A1
(43) Pub. Date: Oct. 3, 2002

(54) Dual threshold correlator

(75) Inventors: Samuel L. Thomasson, Gilbert, AZ (US); Franklyn H. Story, Chandler, AZ (US); Scott E. Harrow, Scottsdale, AZ (US); Judy Mae Fong, Chandler, AZ (US); Justin L. Allen, Mesa, AZ (US)

Correspondence Address: Paul F. Wille, 6407 East Clinton Street, Scottsdale, AZ, 85254, US

(73) Assignee: Acoustic Technologies, Inc.

(21) Appl. No.: 09/824,359

(22) Filed: Apr. 2, 2001

(51) Int. Cl. H04M 1/00; H04M 3/00

(52) U.S. Cl. 379/350

(57) ABSTRACT

Correlation is improved by comparing the output of a multiplier and low pass filter to a first threshold and incrementing a counter when the output from the filter exceeds the first threshold; comparing the output of the filter to a second threshold and decrementing the counter when the output is below a second threshold. Correlation is indicated by the count in the counter exceeding a predetermined amount.

### CROSS-REFERENCE TO RELATED APPLICATIONS

This application describes an improvement to the correlator disclosed in application Ser. No. 09/435,374, filed Nov. 5, 1999, entitled Background Communication Using Shadow of Audio Signal, assigned to the assignee of this invention, and now U.S. Pat. No. ______ . The invention can also be used in the system disclosed in application Ser. No. 09/769,564, filed Jan. 25, 2001, entitled Narrow Band Shadow Encoder, assigned to the assignee of this invention, and now U.S. Pat. No. ______ . The contents of these two copending applications are incorporated by reference into this application.

### BACKGROUND OF THE INVENTION

This invention relates to a circuit for detecting a signal among other signals and, in particular, to a circuit using two correlators operating at different thresholds to determine correlation. The circuit is particularly useful for detecting a “shadow” signal on a telephone line. As used herein, a telephone “line” includes a radio link as used for cellular telephones.

At present, there are two kinds of echo in a telephone system, an acoustic echo between an earphone or a speaker and a microphone and an electrical echo occurring in the switched network for routing a call between stations. In a handset, acoustic echo is typically not much of a problem. In speaker phones, where several people huddle around a microphone and loudspeaker, acoustic feedback is much more of a problem. Hybrid circuits (two-wire to four-wire transformers) located at terminal exchanges or in remote subscriber stages of a fixed network are the principal sources of electrical echo, also known as line echo.

An echo is perceived by a human ear as an echo if the delay is greater than approximately fifty milliseconds. Acoustic echoes and line echoes typically far exceed this threshold. Between about twenty milliseconds and about fifty milliseconds, an echo can impart a certain richness to a sound, as is often done to enhance the thin voices of some recording artists.

It has been discovered that imperceptible echoes, that is, echoes having a delay less than about fifty milliseconds, can be used to transmit data in the voice band during a telephone conversation. The need for such capability has long existed. Telephones, and particularly cellular telephones, transmit considerable amounts of data prior to completing a call, i.e. prior to making a connection to the other party. Some data is transmitted after a party hangs up. The problem is that no data is transmitted during a call. The reason is obvious, no one wants a telephone beeping away in the background or the hiss of a multiplexed signal during a call.

The above-identified copending applications describe a system in which an audio signal is delayed less than fifty milliseconds to produce a shadow signal that is combined with the original signal and coupled to the line output of a telephone. In the later filed application, an audio signal is divided into bands, which increases the amount of data that can be sent and improves correlation, among other advantages.

Shadow correlation begins with a zero-crossing detector that re-shapes the line input signal into a square wave and then sent to a shift register for delay. The synchronized square wave is correlated with the delayed signal by a digital comparison in the form of an exclusive-or (XOR) gate and counter that act as a multiplier and integrator. The counter is cleared periodically. The count is compared with a threshold value set by software. If the count exceeds the threshold value within the available time frame, the event is interpreted as indicating the presence of a shadow.

Voice signals have a large, periodic content. Attempting to correlate to a periodic delay is difficult because of false indications of correlation. It has been found that, in some circumstances, adding one or more shadow signals to the original can cause constructive and destructive interference that corrupts the spectral content of the original signal, particularly if plural shadows are added. Plural shadows can interfere with each other or with the original signal. The second of the above-identified applications reduces the problem by dividing the line signal into bands prior to looking for a shadow signal.

Despite these advances, the complexity of the signal on a telephone line is such that improved correlation is desirable. Part of the problem is the complexity of the signal. A purely random noise signal and its shadow will correlate only if the delay of the original signal matches the delay of the shadow substantially exactly. One cannot tune through a range of delays and look for a stronger signal as one approaches correlation as if one were tuning a radio. Correlation either exists or it does not. Correlation is only slightly less severe with the audio signal on a telephone line.

One can improve correlation by increasing sample size. This requires either a higher sample rate or a longer sample interval. Either way, the amount of data that must be processed is increased, which is undesirable. A longer sample interval also slows the system, which is undesirable. What is desired is to minimize correlation errors while minimizing correlation time.

In view of the foregoing, it is therefore an object of the invention to provide an apparatus and method for improved correlation of complex waves.

Another object of the invention is to communicate data, including control signals, over a telephone line during a conversation.

A further object of the invention is to provide an improved apparatus and method for communicating data over a telephone line simultaneously with voice signals, i.e. without multiplexing voice and data.

Another object of the invention is to provide an improved apparatus and method for detecting control signals in a telephone line during a call.

A further object of the invention is to further improve a multi-band shadow detection system.

### SUMMARY OF THE INVENTION

The foregoing objects are achieved, according to one aspect of the invention, by delaying an audio signal and applying the delayed and undelayed signals to an exclusive-NOR gate, counting the number of logic ones from the exclusive-NOR gate in a first counter, incrementing a second counter when the count is above a first threshold, decrementing the second counter when the count is below a second threshold; and periodically resetting the first counter. Correlation is indicated by the count in the second counter exceeding a threshold. Correlation is further enhanced, in accordance with a second aspect of the invention by filtering the line input of a telephone with a plurality of band pass filters and correlating the output from each filter to detect a shadow in any of the bands.

### BRIEF DESCRIPTION OF THE DRAWINGS

A more complete understanding of the invention can be obtained by considering the following detailed description in conjunction with the accompanying drawings, in which:

FIG. 1 is a block diagram of a shadow encoder;

FIG. 2 is a block diagram of a circuit for encoding two shadows;

FIG. 3 is a block diagram of a circuit for decoding two shadows;

FIG. 4 is a block diagram of a shadow encoder constructed in accordance with one aspect of the invention;

FIG. 5 is a more detailed block diagram of a circuit for decoding two shadows;

FIG. 6 is a block diagram of a decoding system constructed in accordance with a preferred embodiment of the invention; and

FIG. 7 is a block diagram of a telephone constructed in accordance with a preferred embodiment of the invention.

### DETAILED DESCRIPTION OF THE INVENTION

As illustrated in FIG. 1, the invention operates by delaying a signal a small amount, less than fifty milliseconds, to produce an echo, herein called a “shadow” to distinguish it from perceptible echoes, and adding the shadow to the original signal. The signal, and the delay, can be analog or digital.

Delay circuit 11 is preferably a switched capacitor network that stores samples of the signal on input 12. The delay is produced by reading the samples a predetermined time after writing. If delay 11 has one hundred forty four storage sites clocked at a sample frequency of 44.1 kHz., then a three millisecond delay is produced by reading one hundred thirty two sites following the write signal. A plurality of shadows can be created by reading a plurality of storage sites. U.S. Pat. No. 6,166,573 discloses high resolution analog and digital delay lines suitable for use in this invention.

Summation circuit 14 is preferably active, e.g. an operational amplifier, rather than passive, e.g. a resistive summing network. Output signal 15 can be filtered, digitized, converted back to analog form, etc. in a telephone switching network without losing intelligibility or the shadow. Digital information can be represented by the presence or absence of a shadow to indicate a one or a zero but it is preferred to use two shadows to convey digital information.

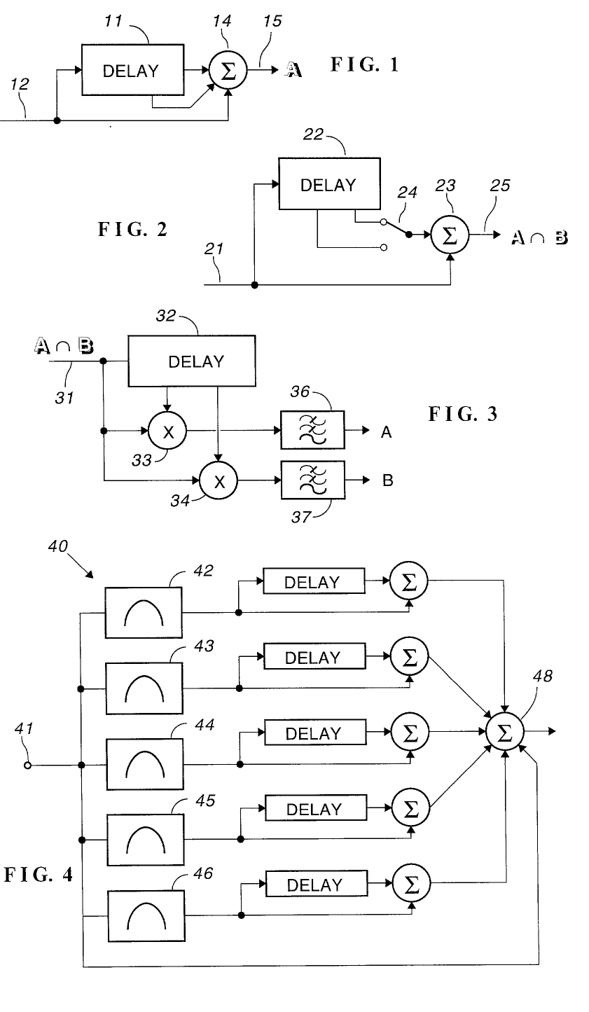

FIG. 2 is a block diagram of a circuit for modulating an audio signal with data. Input 21 is coupled to delay 22 and to summation circuit 23. Delay 22 includes two taps, e.g. at 2.25 milliseconds and at 3.0 milliseconds. Depending upon which tap is selected, the output signal includes either shadow A or shadow B. The shadows are alternative in this example of the invention but could be simultaneous for other applications.

Tests have shown that a difference of about six percent in the amount of delay produces signals that have essentially zero correlation. Thus, each shadow can be detected even when the shadows are simultaneous and continuous. Tests also indicated that the more random the signal, the less separation is necessary for zero correlation. That is, purely random signals could have shadows separated by much less than one millisecond and still be distinguished. Six percent should be understood as a rule of thumb or a guide dealing with voice signals, not as an absolute lower limit.

FIG. 3 is a block diagram of a circuit for detecting two shadows, whether they be simultaneous or alternative. A signal on input 31 is coupled to delay 32, to one input of correlator 33, and to one input of correlator 34. A second input to correlator 33 is coupled to a first tap on delay 32, e.g. at 2.25 milliseconds. A second input to correlator 34 is coupled to a second tap on delay 32, e.g. at 3.0 milliseconds. The output of correlator 33 is coupled to averaging circuit or low pass filter 36. The output of correlator 34 is coupled to averaging circuit or low pass filter 37.

FIG. 4 is a block diagram of a shadow encoder constructed in accordance with the invention, A signal on input 41 is coupled to band pass filters 42, 43, 44, 45, and 46, each having a different center frequency. The output from each filter is coupled to a shadow encoder as shown in FIG. 1. A single shadow (delay) is shown for the sake of simplicity but more than one shadow can be used per band. The output of each encoder is coupled to summation network 48. The output of summation network 48 is the output of encoder 40.

Except for velar sounds and unvoiced fricatives, a human voice has a substantial periodic content. It has been found that the operation of the shadow encoder is substantially improved if a signal is divided into bands prior to encoding and if the delay chosen is not the period of a frequency within the bandwidth of the filter with which the delay is used. The first condition substantially increases the number of shadows that can be used. The second condition substantially improves detection of a shadow, even where the voice band is not sub-divided.

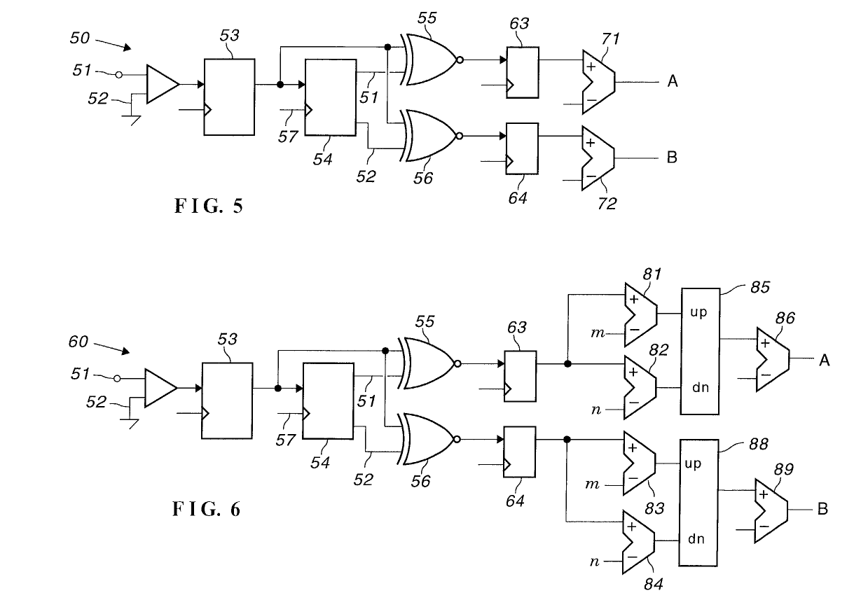

The input signal and delay 32 (FIG. 3) can be analog or digital but digital is preferred. FIG. 5 is a digital implementation of FIG. 3 and has the advantage of being more compact in integrated circuit form than other technologies. For example, shift registers are much smaller delay devices than switched capacitor circuits.

The signal on line input 51 is digitized by applying the signal to a first input of comparator 52 having analog ground as the reference signal coupled to a second input. The output of comparator 52 is coupled to D flip-flop 53 to synchronize the signal with the local sample clock, e.g. 44.1 kHz. The output of D flip-flop 53 is coupled to shift register 54 and to one input of each of exclusive-NOR circuits 55 and 56. Tap 51 from shift register 54 is coupled to a second input of exclusive-NOR circuit 55. Tap 52 from shift register 54 is coupled to a second input of exclusive-NOR circuit 56. The taps are at the 99th and 132nd stages of shift register 54, corresponding to delays of 2.25 milliseconds and 3.0 milliseconds with a 44.1 kHz clock. That is, the taps correspond to the delays used in creating the shadows. A clock signal on input 57, and on similar inputs of other devices in FIG. 5, synchronizes operation.

The output of exclusive-NOR circuit 55 is coupled to counter 63. The output of exclusive-NOR circuit 56 is coupled to counter 64. The combination of an exclusive-NOR circuit and a counter acts as a multiplier and an integrator to indicate a shadow component in the incoming signal. Each sample period causes a multiplication output to be produced and counted. A clear signal (not shown) is sent periodically to counters 63 and 64. It is assumed that a predetermined count within a reset period, e.g. 250 within 60 milliseconds, indicates a correlation of the delayed signal with the input signal. Other quantities could be chosen instead.

The output of counter 63 is coupled to one input of adder 71. The output of counter 64 is coupled to one input of adder 72. A second input of each adder is coupled to a register (not shown) containing a count for comparison. Either one or two registers can be used. If two registers are used, the counts in the registers need not be equal. The count in the register is subtracted from the count in each of counters 63 and 64. A positive output from adder 71 indicates the presence of an “A” shadow. Similarly, a positive output from adder 72 indicates the presence of a “B” shadow.

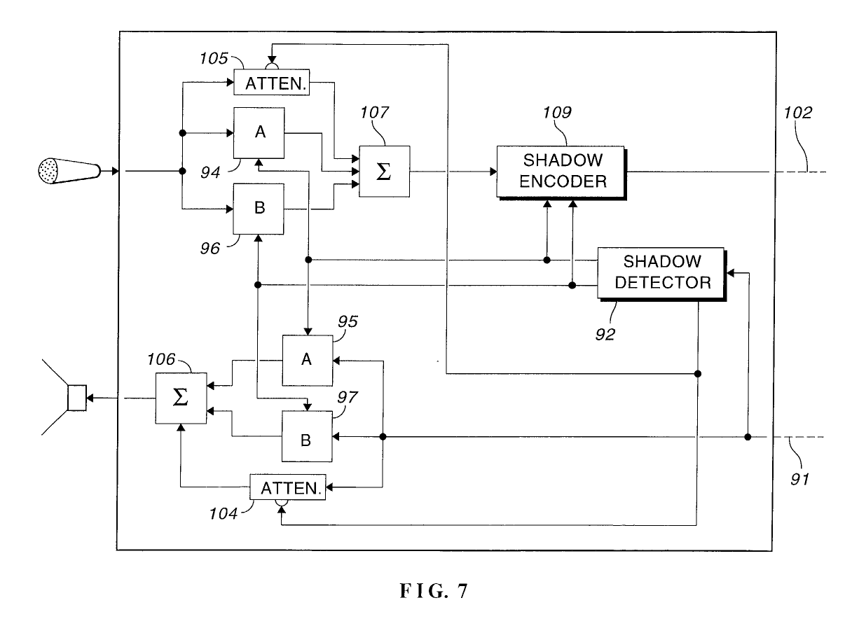

FIG. 6 is a block diagram of a correlation detector constructed in accordance with a preferred embodiment of the invention. Elements common to FIG. 5 have the same reference number. The outputs of counters 63 and 64 are each coupled to two threshold detectors instead of one as in FIG. 5. The output of counter 63 is coupled to one input of each of adders 81 and 82. The output of adder 81 is coupled to the up input of counter 85. The output of adder 82 is coupled to the down input of counter 85. The output of counter 85 is coupled to one input of adder 86. A second input to adder 86 is coupled to a register (not shown) containing a count for comparison with the output from counter 85. Similarly, the output of counter 64 is coupled to one input of each of adders 83 and 84, which control the up and down inputs of counter 88. The output of counter 88 is coupled to one input of adder 89. A second input to adder 89 is coupled to a register (not shown) containing a count for comparison with the output from counter 88.

As in FIG. 5, a signal and a delayed signal are compared bit by bit by exclusive-NOR gates 55 and 56 to increment counters 63 and 64 for each data match. Unlike FIG. 5, the count in each counter is compared with two thresholds rather than one. Adder 81 compares the count in counter 63 with an upper threshold and produces an output when the upper threshold is exceeded, causing counter 85 to increment. Adder 82 compares the count in counter 63 with a lower threshold and produces an output when the count is below the lower threshold, causing counter 85 to decrement. The lower half of FIG. 6, correlating shadow “B”, operates in the same manner. Proper synchronous logic design prevents the cleared counts of counters 63 and 64 from decrementing counters 85 and 88.

Counters 63 and 64 are cleared periodically, which means that correlator 60 operates on a block of data, called a frame, having a programmable size. With a frame size of 50 milliseconds and a sample rate of 44.1 kHz, exclusive-NOR gates 55 and 56 examine 2,205 bits of data before counters 63 and 64 are reset, which means that 2,205 is the maximum count that can be reached. Count m, into the second input of adder 81 is set to somewhat lower than this number and count n into the second input of adder 82 is less than count m and somewhat greater than zero. Values between count m and count n, that are more likely to produce erroneous results, are ignored. Thus, counter 85 is incremented or decremented with the most reliable data available and correlation is much more reliably indicated.

Counters 63 and 64 assure a reliable indication of the presence of a shadow and periodically resetting the counters assures that the system can adapt quickly to changes in condition. Although two shadows are detectable by the apparatus of FIG. 5, the apparatus can be replicated to detect any number of shadows, provided that the shadows are sufficiently separated. The information contained in a shadow can be data or control instructions, e.g. to reduce the gain of an amplifier. Another control function is the selection of one of two groups of complementary comb filters in a telephone by detecting an “A” or a “B” delay and enabling the corresponding set of filters.

FIG. 7 is a block diagram illustrating the portions of the circuit in a telephone that relate to shadow detection. Line input 91 is monitored by shadow detector 92, which is preferably constructed in accordance with FIG. 6 for each band. Shadow encoder 109 is preferably constructed in accordance with FIG. 2. If an “A” shadow is detected, then an enable signal is sent to filters 94 and 95. If a “B” shadow is detected, then an enable signal is sent to filters 96 and 97. If neither shadow is detected, then a signal is sent to attenuators 104 and 105 opening the attenuators, bypassing the filters. Conflicts are resolved by other circuitry (not shown).

A summation circuit provides a convenient means for combining the signals from the filter sets and the attenuator. A switch controlled by shadow detector 92 could be used instead, on the inputs or on the outputs to the filter sets, or both, but this is a more complicated circuit, even though attenuators 104 and 105 could be eliminated by the switches.

The invention thus provides an apparatus and method for improved correlation of complex waves, thereby facilitating communication of data, including control signals, over a telephone line during a conversation. The system operates simultaneously with voice signals, i.e. without multiplexing voice and data. The use of plural band pass filters improves correlation and the use of two thresholds improves correlation still further.

For example, a data set of 9254 frames was constructed using a frame period of 100 milliseconds and a sample rate of 44.1 kHz. To prevent detecting a shadow when a shadow was not present required a threshold count of 6427 for comparator 71 in FIG. 5. Such a threshold allowed shadow detection when shadows were present in only 628 of the 9254 frames, a 6.8% detection rate. In order to obtain a fifty percent detection rate, the threshold was reduced to 5654, which increased the false detection of shadows to 0.64%. A valid shadow detection rate of ninety percent required a threshold of 4694, which increased the false detection of shadows to 28%.

In contrast, using a threshold of 4127 for comparator 82 (FIG. 6) and a threshold of 6127 for comparator 81 resulted in 100% shadow detection and 0% false detection.

Having thus described the invention, it will be apparent to those of skill in the art that many modifications can be made with the scope of the invention. For example, although described in terms of a telephone system, the invention can be used anywhere one wants to send data with an audio signal. The shadow can be removed or left, as desired, in the signal sent to the speaker in the telephone. Data can be sent in addition to or instead of control signals. The correlator can be used for correlating any two signals, not just shadow signals. The logic used can be changed to suit circumstances; e.g. whether a NOR circuit or an OR circuit is used depends upon whether or not an signal is inverted for some reason unrelated to the invention, such as using a spare logic device to equalize delay or to isolate a load.

What is claimed as the invention is:

1. A method for correlating two signals, said method comprising the steps of:
digitizing the signals if they are not already in digital form;
applying the signals to an exclusive-NOR gate;
counting the number of logic ones from the exclusive-NOR gate in a first counter;
incrementing a second counter when the count is above a first threshold;
decrementing the second counter when the count is below a second threshold; and
periodically resetting the first counter.

2. The method as set forth in claim 1 and further comprising the step of:
producing a signal indicative of correlation when the count in the second counter exceeds a third threshold.

3. A method for detecting a shadow in a digital signal, said method comprising the steps of:
delaying the digital signal to produce a delayed signal;
applying the digital signal and the delayed signal to an exclusive-NOR gate;
counting the number of logic ones from the exclusive-NOR gate in a first counter;
incrementing a second counter when the count is above a first threshold;
decrementing the second counter when the count is below a second threshold; and
periodically resetting the first counter.

4. The method as set forth in claim 3, wherein said delaying step is preceded by the step of:
digitizing an audio signal to produce the digital signal.

5. The method as set forth in claim 4 wherein said digitizing step is preceded by the step of:
filtering the audio signal in a band pass filter.

6. In a telephone, an improved correlator for detecting a shadow signal on the line input of said telephone, said correlator comprising:
a delay line having an input coupled to said line input and at least one output;
an exclusive-NOR circuit having a first input coupled to the input of said delay line, a second input coupled to an output of said delay line, and an output;
a first counter coupled to the output of said exclusive-NOR circuit;
an up-down counter;
a first comparator for incrementing said up-down counter when the count in said first counter is above a first threshold;
a second comparator for decrementing said up-down counter when the count in said first counter is below a second threshold;
a third comparator for producing an indication of correlation when the count in said up-down counter exceeds a third threshold.

7. The telephone as set forth in claim 6 and further comprising:
a band pass filter having an output coupled to the input of said delay line.

8. Apparatus for detecting the presence of a shadow in an audio signal, said apparatus comprising:
a band pass filter;
a delay line having an input coupled to said band pass filter and at least one output, wherein the maximum delay of said delay line is less than fifty milliseconds; and
a correlator including
a logic circuit having a first input coupled to the input of said delay line, a second input coupled to an output of said delay line, and an output;
an up-down counter;
a first comparator for incrementing said up-down counter when the output from said logic circuit is above a first threshold;
a second comparator for decrementing said up-down counter when the output from said logic circuit is below a second threshold.

9. The apparatus as set forth in claim 8 and further including:
a third comparator coupled to said up-down counter for producing an indication of correlation when the count in said up-down counter exceeds a third threshold.
